(19) United States
(12) Patent Application Publication
(10) Pub. No.: US 2006/0242008 A1
(43) Pub. Date: Oct. 26, 2006

(54) Behavior encouragement contest method

(76) Inventors: Evers F. Harris, North Las Vegas, NV (US); Monique Harris, North Las Vegas, NV (US)

Correspondence Address: WEISS & MOY PC, 4204 NORTH BROWN AVENUE, SCOTTSDALE, AZ, 85251, US

(21) Appl. No.: 11/110,219

(22) Filed: Apr. 20, 2005

(51) Int. Cl. G06Q 99/00; G07G 1/14; G06Q 30/00

(52) U.S. Cl. 705/14; 705/1

(57) ABSTRACT

A behavior encouragement contest method includes conducting a contest to encourage a behavior among users of a service. The contest results in one or more winners that are provided an award.

### FIELD OF THE INVENTION

This invention relates generally to encouraging behavior, and more particularly to a method of providing contests to award participants demonstrating a desired behavior.

### DESCRIPTION OF THE RELATED ART

Service providers are frequently interested in encouraging one or more behaviors of users of their service. For example, a business may desire to increase customer loyalty, or a law enforcement agency may desire to increase lawful behavior within its jurisdiction. Typical attempts to encourage such behaviors include using techniques such as conducting an advertising campaign, or penalizing behavior by users of the service that is undesirable. Each of these techniques presents inherent drawbacks that decrease its desirability and effectiveness.

Advertising campaigns are expensive and can be inefficient. Typically, an advertisement campaign must be conducted for a long enough duration to produce actual behavioral changes in viewers of the advertisements. Such campaigns are necessarily inefficient because of the difficulty in efficiently targeting the intended audience. Many viewers of the advertisements will not be users of the service, while many users of the service will not ever be exposed to the advertisements. Methods of more directly targeting users of the service, such as by direct mailing techniques, are available but at an increased price per viewer of the advertisements.

In addition, penalizing undesired behavior in users of the service is likely to produce unintended consequences. Users targeted for penalization may become angry or hostile to the service provider and increase rather than decrease the undesired behavior. Further, a service provider perceived as exhibiting such negative behavior to its users may suffer a general loss of goodwill among other actual or potential users of the service.

A need therefore exists to provide a method of encouraging desired behavior among users of a service that overcomes the drawbacks of prior attempts.

### SUMMARY OF THE INVENTION

It is an object of the present invention to provide an inexpensive method that encourages desired behavior among users of a service.

It is another object of the present invention to provide a method of that encourages desired behavior among users of a service that does not reduce the goodwill of the service provider.

The present invention satisfies these needs, and provides other, related, advantages. The foregoing objectives are achieved in the behavior encouragement contest method.

### BRIEF DESCRIPTION OF THE PREFERRED EMBODIMENTS

In accordance with one embodiment of the present invention, a method of encouraging a behavior by users of a service is disclosed. It includes providing a service having multiple users, selecting contest participants from the users, with the contest participants exhibiting a behavior to be encouraged, conducting a contest engaged in by at least two of the contest participants, the contest resulting with at least one winner, and providing an award to the at least one winner.

In accordance with another embodiment of the present invention, a method of assisting a business improve customer loyalty is disclosed. It includes providing multiple business enhancement contests to a business, selecting at least one business enhancement contest, conducting at least one of the selected business enhancement contests, and receiving a compensation from the business.

In accordance with another embodiment of the present invention, a method of assisting an improvement of vehicular safety is disclosed. It includes providing at least one vehicular safety contest, selecting at least one vehicular safety contest, conducting at least one of the selected vehicular safety contests, and receiving a compensation for conducting the vehicular safety contest.

The foregoing and other objects, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a flowchart depicting steps of a method to encourage a behavior in accordance with embodiments of the present invention.

FIG. 2 is a flowchart depicting steps of conducting a business enhancement contest in accordance with embodiments of the present invention.

FIG. 3 is a perspective illustration depicting items for conducting a business enhancement contest in accordance with an embodiment of the present invention.

FIG. 4 is an illustration depicting items for conducting a business enhancement contest in accordance with another embodiment of the present invention.

### DETAILED DESCRIPTION OF EMBODIMENTS OF THE INVENTION

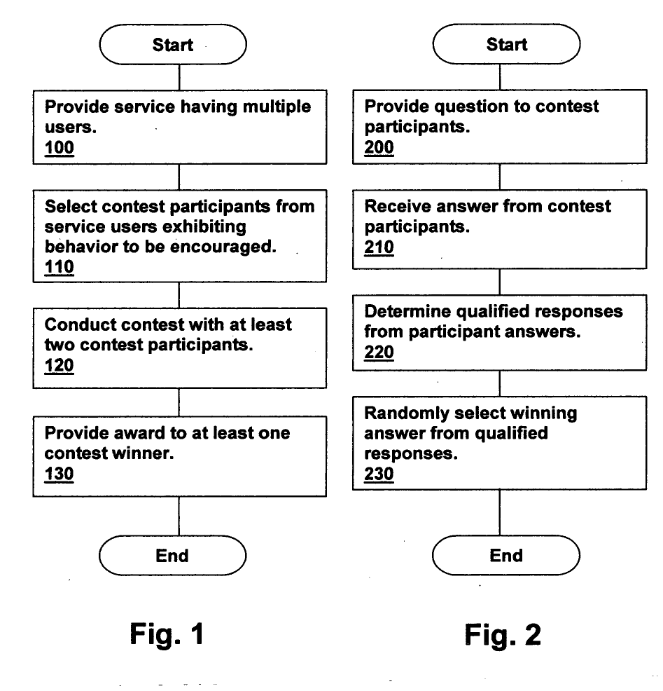

With reference now to the figures, and in particular to FIG. 1 a flowchart depicting steps of a method of encouraging a behavior by users of a service is shown in accordance with an embodiment of the present invention. It includes the steps of providing a service having multiple users of the service (step 100). Multiple contest participants are selected from the users of the service (step 110). The contest participants exhibit a behavior that is desired to be encouraged. A contest is conducted that is engaged in by at least two contest participants (step 120). The contest results with at least one winner that is provided an award (step 130).

In accordance with some embodiments of the present invention, the service is a business desiring to promote customer loyalty. FIG. 2 depicts steps of conducting a contest as a business enhancement contest. A question is provided to the contest participants engaging in the contest (step 200). Contest participants are preferably customers of the business, however, contest participants may also be chosen according to any desired criteria, such as long-time customers, or potential customers, or customers present at the time of the contest, or the like.

An answer to the question is received from each contest participant (step 210). Preferably, game cards are distributed to contest participants providing the question and a space for the answer, along with participant identification information such as name, phone number, or identification number. However, it is within the spirit and scope of the present invention that game cards not be used and instead another method be used for providing the question to and receiving answers from contest participants.

The received answers are examined to determine which answer meets criteria to be a qualifying response (step 220). At least one winning answer is randomly selected from the qualifying responses (step 230), and the winner that is provided an award is the contest participant that provides the winning answer. Preferably, the award is provided as a cash award; however, the award may take other forms such as gift certificates, free or discounted products or services, or the like.

The business enhancement contest encourages customer loyalty by providing a financial incentive for customers or potential customers to select the business for their source of goods or services rather than the competitors of the business. Other advantages may be obtained such as customer leads for marketing purposes if the participants' information such as name, address, phone number, or the like are collected. In addition, conducting the business enhancement contest will encourage participants to visit the business to participate in the contest, increasing the likelihood of sales and exposure to advertising or marketing programs at the contest.

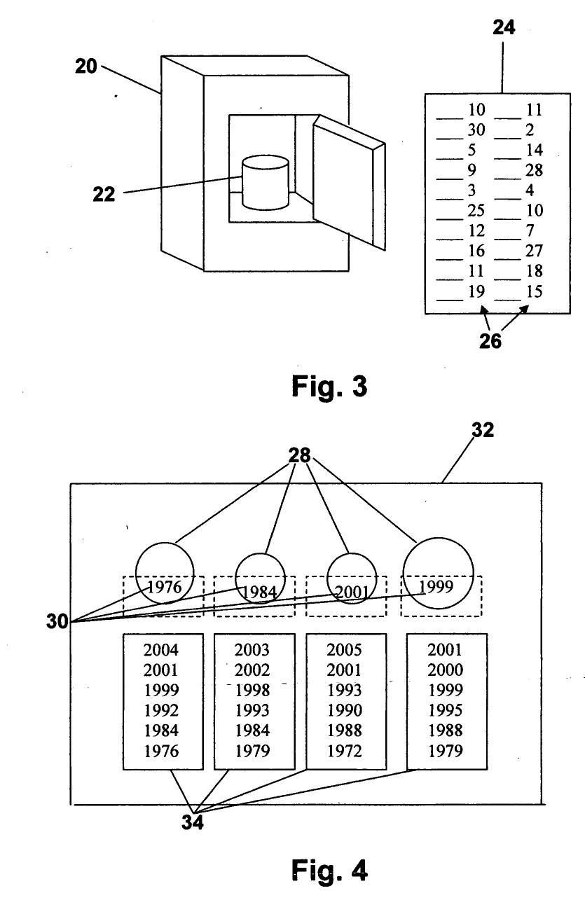

In accordance with one embodiment of the present invention, a business enhancement contest features providing a vault 20 containing an award 22 as depicted in FIG. 3. A game card 24 having a plurality of numbers 26 is provided to each contest participant. One number 26 is predetermined as a winning number. It is preferred that the winning number is related to opening vault 20, such as when vault 20 is configured to unlock when the winning number is entered, or when the winning number is the last number of a combination that unlocks vault 20, or the like. Participants are instructed to select a single number from game card 24 and return game cards 24. If more than two participants select the winning number, two winners are randomly chosen from the participants that correctly selected the winning number. Winners are rewarded in a ceremony where vault 20 is opened and award 22 is distributed to the winners.

In accordance with another embodiment of the present invention, a business enhancement contest features providing an award to one or more contest participants that correctly guess the year of a coin 28. Coins 28 such as a penny, nickel, dime, and quarter are mounted to bulletin board 32 for viewing by contest participants. The year 30 of each coin 28 is concealed. A list of years 34 is provided for each coin 28, with one year of the list 34 matching the concealed year 30 of the corresponding coin 28. Contest participants are instructed to select one year from the list of years 34 for at least one coin 28.

An award is provided for correctly selecting the correct year 30 of any coin 28, such as $20 for the quarter, $30 for the dime, $40 for the nickel, and $50 for the penny, as one example. If multiple participants provide qualifying responses that select the correct year 30 of a coin 28, two winners are randomly selected from the participants providing qualifying responses for that coin 28 and the award amount for that coin 28 is provided to each. Further, a bonus award may be provided to each such randomly selected winner.

In accordance with another embodiment of the present invention, a business enhancement contest features providing an award to one or more contest participants that correctly match a list of colors to a list of monetary values. A list of monetary values and a list of colors are provided to contest participants. Preferably, both lists are of equal length, allowing a one-to-one correspondence of colors to monetary values. A winning association of each one of the colors with one of the monetary values is determined. Contest participants are instructed to associate each one of the colors with one of the monetary values, and each contest participant provides one such association. Qualifying responses from contest participants having the winning association are determined, and an award is provided to two participants randomly selected from those providing qualifying responses, if any.

In accordance with another embodiment of the present invention, a business enhancement contest features providing an award to one or more contest participants that provide customer satisfaction information for any business, not just the business associated with the business enhancement contest. Contest participants are instructed to identify two businesses whose conduct has generated a complaint and identify the complaint for each identified business. Qualifying responses are those responses from participants that provide the name and a complaint for two businesses. One winner is randomly selected from those participants providing qualifying responses and provided an award.

Preferably, the business enhancement contest is repeated every two hours starting with a predetermined award amount, such as $100. When any qualifying response identifies the business associated with the contest, the award amount is decreased by an amount such as $10, and the award amount is increased if no qualifying response identifies the business associated with the contest. The award adjustments preferably take effect during the same contest, or may instead take effect for a subsequent contest.

In accordance with another embodiment of the present invention, a business enhancement contest features providing an award to one or more contest participants that provide information relating to their job description. A list of fields of employment is provided. For example, the list may include employment fields such as: “Construction, Electronics, Newspapers, Carpet Cleaning, Grocery, Warehouse, Mechanic, Restaurant, Entertainment, Business, Casino, Government, Legal, Medical, Postal Service, Broadcasting, Dancing, Education, Fast Food, and Miscellaneous,” or the like. A monetary value is associated with each field: for example, “Construction” may be associated with $5, while “Fast Food” may be associated with $100. Preferably the monetary amount associated with each field is not disclosed to contest participants.

Contest participants are each instructed to indicate his or her field of employment from the list. Participant responses that that include a selection from the list identifying the participant's field of employment are qualified for a random drawing. One qualified response is randomly selected as the winning response, and the participant submitting the winning response is awarded the monetary value associated with his or her field of employment. In addition to encouraging customer loyalty, the employment data provided by participant responses may be recorded and used for future marketing or promotional programs.

In accordance with another embodiment of the present invention, a business enhancement contest features providing an award to one or more contest participants that correctly identify information commonly found on business cards. Multiple business terms are provided, and letters of each business term are replaced with blanks. For example, the term “COMPANY NAME” may have letters replaced with blanks to appear as “C_P_N_N_{——}E” while “EMAIL ADDRESS” may appear as “_{————}L_D_R_S_”.

Contest participants are instructed to identify each business term by providing the letters that have been replaced by blanks for each business term provided. Participant responses that correctly identify each business term are qualified for a random drawing. One qualified response is randomly selected as the winning response, and the participant providing the winning response is provided with a monetary award.

In accordance with another embodiment of the present invention, a business enhancement contest features providing an award to one or more contest participants that correctly compute a sum of monetary values. Game cards are provided with each game card having indicia including at least two monetary amounts. The game cards are distributed to contest participants, who are instructed to provide a sum of the monetary amounts on their game card.

Responses returned by contest participants are qualified for a random drawing when the responses both provide a correct sum of the monetary amounts of the participant's game card and the sum matches a determined award amount. A winning response is randomly selected from qualifying responses, and the participant providing the winning response is awarded the award amount.

In accordance with another embodiment of the present invention, a business enhancement contest features providing an award to one or more contest participants that provide their cell phone number whose digits sum within a specified range. Participants are instructed to provide both a cell phone number used by the participant and also to provide a sum of the digits of the cell phone number.

Participant responses providing a cell phone number and a correct sum of the digits of the number that is lower than a determined amount qualify for a random drawing. For example, the determined amount may be 32, so that the number 444-4444, summing to 28, would qualify, but 555-5555, summing to 35, would not. A winning response is randomly selected from qualifying responses, and the winner is notified by a phone call to the cell phone number on the winning response. Notifying the winner by cell phone call increases the excitement of the contest as participants may eagerly await the ring of their cell phone at an award ceremony, and also prevents awarding fraudulent responses because only an authentic cell phone number operated by the winner can produce notification of winning the award.

In accordance with another embodiment of the present invention, a business enhancement contest features providing an award to one or more contest participants that correctly select one of multiple provided monetary values. Participants are provided with a list of monetary values, for example, the list may contain thirty values ranging from $5 to $50 in $5 increments, $60 to $150 in $10 increments, and $200 to $380 in $20 increments. One of the monetary values on the list is determined as a winning value. Contest participants are instructed to select one of the monetary values. Participant responses that select the winning value are qualified for a random drawing. Up to two winning responses are randomly selected from the qualified responses, and each participant contributing a winning response is awarded the winning value.

In accordance with another embodiment of the present invention, a business enhancement contest features providing an award to one or more contest participants that correctly guess a winning award amount from a provided range of award amounts. A monetary range is provided to contest participants, for example: $100 to $1,200. A winning award amount is determined, such as $800. Contest participants are instructed to select a monetary value within the range. Participant responses that correctly select the winning value are qualified for a random drawing. Preferably, at most two participants will be awarded the winning award amount. If more than two qualified responses are received, two winning responses are randomly selected from the qualifying responses.

In accordance with another embodiment of the present invention, a business enhancement contest features providing an award to one or more contest participants that correctly deduce a winning award amount from a riddle. Contest participants are provided several money-related trivia questions and a riddle. The riddle has a winning solution that equals the contest award amount. The riddle refers to each of the money-related trivia questions so that an incorrect answer to the money-related trivia questions may result in an incorrect solution to the riddle. Participant responses that provide the correct winning solution to the riddle are qualified for a random drawing. One winning response is randomly selected from the qualifying responses, and the participant providing the winning response is awarded a monetary amount equaling the winning solution to the riddle.

For example, three money-related trivia question may provided such as: “Which denomination bill has the Treasury Building on its back?”; “Which President's face is on the $5 bill?”; and “Who was the first President of the United States of America?” The corresponding riddle may be “How much money are the Presidents giving away?”

This riddle has several possible solutions, only one of which is determined to be the winning solution. For example, the $10 bill features the Treasury Building on its back and Hamilton on its face, Lincoln is featured on the $5 bill, and Washington was the first President and featured on the $1 bill. One solution of the riddle may be $16, the sum of the three bills denominations related to the trivia questions. Another solution may be $1,051, the digits of the bill denominations in the order of the questions. However, in recognition that Alexander Hamilton was not a President, the winning solution may instead be $6, the sum of the $5 and $1 bill featuring Presidents, or $51, the sequence of digits identified by the second and third questions.

In accordance with another embodiment of the present invention, a business enhancement contest features providing an award to all contest participants that correctly guess an award time. One hour is determined to be an award hour. Preferably, the award hour is during the normal operation hours of the business associated with the contest, and contest participants are instructed to predict the correct award hour. Each participant provides an answer predicting the award hour. The answers received from contest participants are examined for any answer containing a disqualifying response predicting an incorrect award hour. If no disqualifying responses are received, all participants are provided an equal share of the award during the award hour. However, if any disqualifying responses are received, no award will be provided to any participant.

In addition to customer loyalty, the business enhancement contest of the present embodiment also encourages a sense of unity and teamwork among contest participants, in that all participants must agree on the correct hour for any participant to win the award. It is envisioned that the contest will be conducted repeatedly, such as daily or weekly, to encourage repeated returns to the business by potential contest participants, and that any time the award is distributed to contest participants, the award amount for the following contest is increased.

In accordance with another embodiment of the present invention, a business enhancement contest features providing an award to one or more contest participants that correctly select one of multiple provided monetary values. Participants are provided with a list of monetary values, for example: $20, $40, and $60. One of the monetary values on the list is a winning value. Contest participants are instructed to select one of provided monetary values. Participants whose responses correctly select the winning value are qualified to receive an award. Each participant submitting a qualified response is provided an award equivalent to the winning monetary value equally divided by the number of qualifying responses.

In accordance with another embodiment of the present invention, an entity other than the business desiring to encourage customer loyalty may assist the business by providing multiple business enhancement contests to the business. At least one business enhancement contest is selected either by the business, by the assisting entity, or both. The selected business enhancement contest is conducted, and the assisting entity is compensated by the business. The compensation may be a fixed fee, or a proportion of increased sales, or a fee based on increased customer leads arising from the contest, or any other method of compensating the assisting entity. Efficiency is promoted by having a separate entity assist the business in that the assisting entity may develop, refine, and conduct business enhancement contests and offer such service to multiple businesses, relieving each business of independently having to devote time and resources to developing and conducting the business enhancement contest.

In accordance with another embodiment of the present invention, a vehicle safety contest features providing an award to one or more contest participants to promote driving safety. The vehicle safety contest is preferably conducted by one or more local, state or national law enforcement organizations having an interest in improving or maintaining driver safety. An award amount is determined to be provided to contest winners. At least one law enforcement officer is provided to randomly stop vehicle drivers. These randomly stopped vehicle drivers become contest winners that are provided at least a portion of the award amount.

Preferably, the vehicle safety contest is conducted within a determined region, such as a portion of an Interstate highway, a metropolitan area, or one or more school zones, construction areas, or the like. It is further preferred that a designated number of winners share equally in the award amount, and that the award amount is increased in response to improved driver safety.

For example, the vehicle safety contest may be conducted for one month along a 100 mile stretch of highway where improved driver safety is desired. A contest goal is set, such as the goal of having zero tickets and zero accidents for along the stretch of highway for a twelve-hour period. An award may be determined to begin at $2,000, and for every twelve hour period of the contest that there are no accidents or speeding tickets distributed along the designated stretch of highway, the award may be incremented by $50. A specific number of winners, for example, eighty, may be predetermined to share equally in the award, with the eighty winners being drivers along the highway that are randomly selected and stopped by one or more law enforcement officers. The law enforcement officers will provide these winners with a monetary award or a certificate allowing the winner to claim the award immediately or at the conclusion of the contest. Alternatively, the monetary award may be distributed in a way other than by a law enforcement officer stopping the vehicle. For example, it is also within the spirit and scope of this invention that license plates of vehicle drivers achieving the contest goal of driving safely could be identified by a camera or some other mechanism in order to locate the vehicle driver for purposes of disbursing the award. The contest may also be conducted so that each time the contest goal is not met, such as a twelve-hour period where a speeding ticket is distributed or an accident occurs, the award amount is reduced.

In accordance with another embodiment of the present invention, a vehicle safety contest features a competition between different driving regions to achieve a second goal. For example, two different highways may be chosen for the contest, and only the winners selected from the highway that has the fewest number of speeding tickets and accidents combined during the contest period will receive an award. In this way, driver safety may be encouraged over a larger or multiple areas without substantially requiring more award money than for a contest in a single area. In addition, regional rivalries may develop as drivers compete for the safest highways, roads, school zones, etc., in order to improve the chance of distributing award money within the safest region. Once developed, these regional rivalries may continue after the conclusion of the contest, as drivers continue to take pride in having the safest roads of the area.

The vehicle safety contest thus provides an economic incentive to all drivers to drive safely for the duration of the contest. Safe driving will not only improve each driver's chance of being selected as a winner of the contest, but also to increase the total amount of the award to be distributed by the winners. By providing an economic incentive to encourage safe driving over a prolonged period, safe driving behavior is likely to become habitual in at least some drivers, thus promoting a long-term effect after the conclusion of the contest.

In accordance with another embodiment of the present invention, an entity other than a law enforcement agency may assist an improvement of vehicular safety by providing at least one vehicular safety contest from which at least one vehicular safety contest is selected. The selected vehicular safety contest is conducted, and the assisting entity is compensated for conducting the contest. The compensation may be a fixed fee, or proportional to the contest increased safety results, or any other method of compensating the assisting entity. Efficiency is promoted by having a separate entity develop, refine, and conduct vehicular safety contests and offer such service to multiple law enforcement jurisdictions, relieving each jurisdiction of independently having to devote time and resources to developing and conducting the vehicular safety contest.

While the invention has been particularly shown and described with reference to the preferred embodiments thereof, it will be understood by those skilled in the art that the foregoing and other changes in form, and details may be made therein without departing from the spirit and scope of the invention. For example, although it is preferred in the business enhancement contest that game cards are used for participants to provide responses, other methods such as a showing of hands, a telephone dial-in system, or simply oral responses may be used. As another example, although it is envisioned that the contests are conducted with participants physically present, contests may also include or exclusively comprise remote participants, such as by telephone, email, facsimile, or the like. As yet another example, although a specified number of winners may be preferred, any desired number of winners may be provided an award without departing from the spirit and scope of the present invention.

What is claimed is:

1. A method of encouraging a behavior by users of a service, comprising the steps of:
providing a service having a plurality of users;
selecting a plurality of contest participants from said plurality of users, said contest participants exhibiting a behavior to be encouraged;
conducting a contest engaged in by at least two of said contest participants, said contest resulting with at least one winner; and
providing an award to said at least one winner.

2. The method of claim 1, wherein said service is a business, wherein said users are customers of said business, wherein said behavior is customer loyalty to said business, wherein said contest is a business enhancement contest, and wherein said conducting said contest comprises the steps of:
providing a question to all said contest participants engaging in said contest;
receiving an answer to said question from each said contest participant engaging in said contest;
determining at least one qualifying response to said question from said answers that are received;
randomly selecting at least one winning answer from said at least one qualifying response, wherein said at least one winner that is provided an award being said contest participant providing said winning answer.

3. The method of claim 2, wherein said step of conducting said contest further comprises:
providing a vault, said vault containing said award;
providing a plurality of numbers to said contest participants; and
designating at least one said number as a winning number, wherein said question comprises an instruction to select one of said numbers, wherein each said answer comprises a selection of one of said numbers by each said contest participant engaging in said contest, wherein said qualifying response comprises a selection of said winning number, and wherein said providing an award comprises the steps of:
opening said vault; and
providing said award contained in said vault to said at least one winner.

4. The method of claim 2, wherein said step of conducting said contest further comprises:
providing a bulletin board;
providing a plurality of coins, each said coin having a denomination distinct from the denomination of all other said coins, each said coin further having a year;
concealing said year of each said coin;
mounting said coins on said bulletin board; and
providing a plurality of years for each said coin, each said plurality of years comprising said concealed year of said coin, wherein said question comprises an instruction to select one said year from said plurality of years for at least one said coin, wherein each said answer comprises a selection of one said year for at least one said coin by each said contest participant engaging in said contest, and wherein said qualifying response comprises a selection of said concealed year of at least one said coin.

5. The method of claim 2, wherein said step of conducting said contest further comprises:
providing a plurality of monetary values;
providing a plurality of colors, wherein the number of said colors equals the number of said monetary values; and
determining a winning association of each one of said colors with a single one of said monetary values, wherein said question comprises an instruction to associate each one of said colors with a single one of said monetary values, wherein each said answer comprises an association of each one of said colors with a single one of said monetary values, and wherein said qualifying response comprises said winning association.

6. The method of claim 2, wherein said question comprises an instruction to identify two businesses whose conduct has generated a complaint and identify said complaint for each said identified business, wherein said qualifying response provides the name and a complaint for two businesses, wherein said award is decreased if any said qualifying response identifies said business conducting said contest, and wherein said award is increased if no said qualifying response identifies said business conducting said contest.

7. The method of claim 2, wherein said step of conducting said contest further comprises:
providing a list of fields of employment; and
associating with each said field of employment a monetary value, wherein said question comprises an instruction for each said contest participant to indicate a field of employment of said contest participant from said list, wherein said qualifying response comprises a selection from said list identifying said field of employment of said contest participant, and wherein said award comprises said monetary value associated with said field of employment of said winner.

8. The method of claim 2, wherein said step of conducting said contest further comprises:
providing a plurality of business terms; and
replacing a plurality of letters of each said business term with blanks, wherein said question comprises an instruction to identify each said business term, and wherein said qualifying response correctly identifies each said business term.

9. The method of claim 2, wherein said step of conducting said contest further comprises:
providing a plurality of game cards, each said card having indicia comprising at least two monetary amounts;
distributing at least one said game card to each said contest participant; and
determining an amount of said award, wherein said question comprises an instruction to each said contest participant to provide a sum of said monetary values of each said at least one game card of said contest participant, wherein each said answer comprises an attempt by one said contest participant to provide a sum of said monetary values of said game card of said contest participant, and wherein said qualifying response comprises a correct sum equaling said amount of said award.

10. The method of claim 2, wherein said question comprises an instruction to provide a cell phone number, wherein said qualifying response comprises a sum of the digits of said cell phone number lower than a pre-determined amount, and wherein said step of conducting said contest further comprises the step of notifying said winner at said cell phone number provided by said winner.

11. The method of claim 2, wherein said step of conducting said contest further comprises:
providing a plurality of monetary values; and
selecting a winning value from said monetary values, wherein said question comprises an instruction to select one of said monetary values, wherein said qualifying response comprises a selection of said winning value by said contest participant, and wherein said award is said winning monetary value.

12. The method of claim 2, wherein said step of conducting said contest further comprises:
providing a range of monetary values; and
selecting a winning value within said range of monetary values, wherein said question comprises an instruction to select a monetary value within said range of monetary values, wherein said qualifying response comprises a selection of said winning value by said contest participant, and wherein said award is said winning monetary value.

13. The method of claim 2, wherein said question comprises a plurality of money-related trivia questions and a riddle, said riddle having a winning solution being a monetary value, said riddle referring to each of said money-related trivia questions so that an incorrect answer to any of said money-related trivia questions results in an incorrect solution to said riddle, wherein said qualifying response comprises said correct solution to said riddle, and wherein said award is said correct solution to said riddle.

14. The method of claim 1, wherein said service is a business, wherein said users are customers of said business, wherein said behavior is customer loyalty to said business, wherein said contest is a business enhancement contest, and wherein said conducting said contest comprises the steps of:
determining a time for providing said award;
providing a question to all said contest participants engaging in said contest, said question comprises an instruction to predict said time that is determined;
receiving an answer to said question from each said contest participant engaging in said contest;
examining said answers that are received for any said answer comprising a disqualifying response, said disqualifying response comprising a time other than said time that is determined, wherein said at least one winner that is provided an award being all said contest participants when no said answer comprising said disqualifying response is received.

15. The method of claim 1, wherein said service is a business, wherein said users are customers of said business, wherein said behavior is customer loyalty to said business, wherein said contest is a business enhancement contest, and wherein said conducting said contest comprises the steps of:
providing a plurality of monetary values to said contest participants;
determining an amount of said award, said amount of said award being one of said monetary values;
providing a question to all said contest participants engaging in said contest, said question comprises an instruction to predict said amount of said award;
receiving an answer to said question from each said contest participant engaging in said contest; and
determining at least one qualifying response to said question from said answers that are received, said qualifying response comprising said amount of said award, wherein said at least one winner that is provided an award being all said contest participants providing said qualifying response.

16. The method of claim 1, wherein said service is law enforcement, wherein said users are vehicle drivers, wherein said behavior is driving safety, wherein said contest is a vehicle safety contest, and wherein said conducting said contest comprises the steps of:
determining an amount of said award;
determining at least one vehicle driver exhibiting said driving safety; and
providing at least one said vehicle driver exhibiting said driving safety with at least a portion of said award.

17. The method of claim 16, wherein said conducting said contest further comprises:
determining a first contest goal in conformity with one of a number of vehicular speeding incidents and a number of accidents within a determined time period; and
increasing said amount of said award in response to achieving said first contest goal.

18. The method of claim 16, wherein said conducting said contest further comprises the step of decreasing said amount of said award in response to not achieving said first contest goal.

19. The method of claim 16, further comprising the steps of:
determining a plurality of contest regions;
determining a second goal comprising one said contest region having fewer of at least one of vehicular speeding incidents accidents and vehicular accidents than the other said contest regions, and wherein said at least one winner comprises said at least one vehicle driver that within said contest region achieving said second goal.

20. A method of assisting a business improve customer loyalty, comprising the steps of:
providing a plurality of business enhancement contests to a business;
selecting at least one said business enhancement contest;
conducting at least one of said at least one business enhancement contest that is selected; and
receiving a compensation from said business.

21. A method of assisting an improvement of vehicular safety, comprising the steps of:
providing at least one vehicular safety contest;
selecting at least one said vehicular safety contest;
conducting at least one of said at least one vehicular safety contest that is selected; and
receiving a compensation for said conducting.
